(19) United States
(12) Patent Application Publication
(10) Pub. No.: US 2004/0105388 A1
(43) Pub. Date: Jun. 3, 2004

(54) Router node with control fabric and resource isolation therein

(76) Inventors: David Wilkins, San Jose, CA (US); Shekar Nair, San Jose, CA (US); Paramjeet Singh, Morgan Hill, CA (US); Frank Lawrence, Morgan Hill, CA (US)

Correspondence Address: Allegro Network, Inc., 1999 S. Bascom Ave, Suite 700, Campbell, CA, 95008, US

(21) Appl. No.: 10/307,652

(22) Filed: Dec. 2, 2002

(51) Int. Cl. H04J 1/16

(52) U.S. Cl. 370/235; 370/351

(57) ABSTRACT

A router node for a broadband Internet access carrier environment scales in the data forwarding plane and the routing control plane. The router node architecture ensures satisfactory isolation between routing instances and satisfactory isolation between data forwarding plane and routing control plane resources bound to each routing instance. The router node has a dedicated control fabric which is nonblocking. The control fabric is reserved for traffic involving at least one module in the routing control plane. The control fabric further provides resources, such as physical paths, stores and tokens, dedicated to particular pairs of modules on the control fabric. The control fabric supports a configurable number of routing modules. The router node may be arranged in a multi-router configuration in which the control fabric has at least two routing modules.

### BACKGROUND OF INVENTION

Various architectures exist for router nodes that provide broadband Internet access. Historically, such architectures have been based on a model of distributed data forwarding coupled with centralized routing. That is, router nodes have been arranged to include multiple, dedicated data forwarding instances and a single, shared routing instance. The resulting nodes have provided isolation of data forwarding resources, leading to improved data forwarding plane performance and manageability, but no isolation of routing resources, leading to no comparable improvement in routing control plane performance or manageability.

It is becoming increasingly impractical for the carriers of Internet broadband service to support the “stand-alone router” paradigm for router nodes. Carriers must maintain ever increasing amounts of physical space and personnel to support the ever increasing numbers of such nodes required to meet demand. Moreover, the fixed nature of the routing control plane in such nodes restricts their flexibility, with the consequence that a carrier must often maintain nodes that are only being used as a fraction of their forwarding plane capacity. This is done in anticipation of future growth, or because the node is incapable of scaling to meet the ever increasing processing burden on the lone router.

Recently, virtual routers have been developed that seek to partition and utilize stand-alone routers more efficiently. Such virtual routers are typically implemented as additional software, stratifying the routing control plane into multiple virtual routers. However, since all virtual routers in fact share a single physical router, isolation of routing resources is largely ineffectual. The multiple virtual routers must compete for the processing resources of the physical router and for access to the shared medium, typically a bus, needed to access the physical router. Use of routing resources by one virtual router decreases the routing resources available to the other virtual routers. Certain virtual routers may accordingly starve-out other virtual routers. In the extreme case, routing resources may become so oversubscribed that a complete denial of service to certain virtual routers may result. Virtual routers also suffer from shortcomings in the areas of manageability and security.

What is needed, therefore, is a flexible and efficient router node for meeting the needs of broadband Internet access carriers. Such a router node must have an architecture that scales in both the data forwarding plane and the routing control plane. Such a router node must ensure satisfactory isolation between multiple routing instances and satisfactory isolation between the data forwarding plane and routing control plane resources bound to each routing instance.

### SUMMARY OF THE INVENTION

In one aspect, the present invention provides a router node having a dedicated control fabric. The control fabric is reserved for traffic involving at least one module in the routing control plane. Traffic involving only modules in the data forwarding plane bypasses the control fabric.

In another aspect, the control fabric is non-blocking. The control fabric is arranged such that oversubscription of a destination module in no event causes a disruption of the transmission of traffic to other destination modules, e.g. the control fabric is not susceptible to head-of-line blocking. Moreover, the control fabric is arranged such that oversubscription of a destination module in no event causes a starvation of any source module with respect to the transmission of traffic to the destination module, e.g. the control fabric is fair. The control fabric provides resources, such as physical paths, stores and tokens, which are dedicated to particular pairs of modules on the control fabric to prevent these blocking behaviors.

In another aspect, the control fabric supports a configurable number of routing modules. “Plug and play” scalability of the routing control plane allows a carrier to meet its particularized need for routing resources through field upgrade.

In another aspect, the router node is arranged in a multi-router configuration in which the control fabric has at least two routing modules. The control fabric's dedication of resources to particular pairs of modules, in the context of a multi-router configuration, has the advantage that data forwarding resources and routing resources may be bound together and isolated from other data forwarding and routing resources. Efficient and cost effective service provisioning is thereby facilitated. This service provisioning may include, for example, carrier leasing of routing and data forwarding resource groups to Internet service providers.

In another aspect, the router node is arranged in a multi-router configuration in which the control fabric has at least one active routing module and at least one backup routing module. Automatic failover to the backup routing module occurs in the event of failure of the active routing module.

These and other aspects of the invention will be better understood by reference to the following detailed description, taken in conjunction with the accompanying drawings which are briefly described below. Of course, the actual scope of the invention is defined by the appended claims.

### BRIEF DESCRIPTION OF THE DRAWINGS

FIG. 1 shows a routing node in a preferred embodiment;

FIG. 2 shows a representative line module of FIG. 1 in more detail;

FIG. 3 shows a representative routing module of FIG. 1 in more detail;

FIG. 4 shows the management module of FIG. 1 in more detail;

FIG. 5 shows the control fabric of FIG. 1 in more detail; and

FIG. 6 shows the fabric switching element of FIG. 4 in more detail.

### DETAILED DESCRIPTION OF THE PREFERRED EMBODIMENT

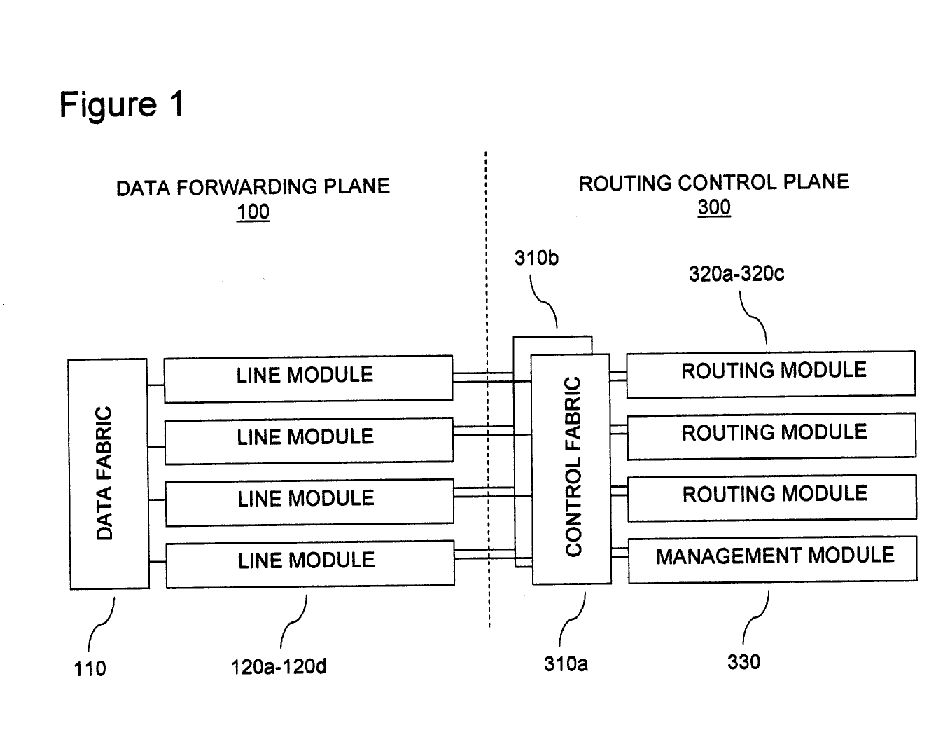

In FIG. 1, a routing node in accordance with a preferred embodiment of the invention is shown. The routing node is logically divided between a data forwarding plane 100 and a routing control plane 300. Data forwarding plane 100 includes a data fabric 110 interconnecting line modules 100a-100d. Routing control plane 300 includes a control fabric 310a interconnecting line modules 120a-120d, routing modules 320a-320c and management module 330. Routing control plane 300 includes a backup control fabric 310b interconnecting modules 100a-100d, 320a-320c and 330 to which traffic may be rerouted in the event of a link failure on control fabric 310a. Control fabrics 310a, 310b are reserved for traffic involving at least one of routing modules 320a-320c or management module 330. Traffic involving only line modules 120a-120d bypasses control fabric 310a and uses only data fabric 110. All of modules 120a-120d, 320a-320c, 330 and fabrics 110, 310a, 310b reside in a single chassis. Each of modules 120a-120d, 320a-320c, 330 resides on a board inserted in the chassis, with one or more modules being resident on each board. Modules 120-120d, 320a-320c are preferably implemented using hardwired logic e.g. application specific integrated circuits (ASICs) and software-driven logic e.g. general purpose processors. Fabrics 110, 310a, 310b are preferably implemented using hardwired logic.

Although illustrated in FIG. 1 as having three routing modules 320a-320c, the routing node is configurable such that control fabrics 310a, 310b may support different numbers of routing modules. Routing modules may be added on control fabrics 310a, 310b in “plug and play” fashion by adding boards having routing modules installed thereon to unpopulated terminal slots on control fabrics 310a, 310b. Each board may have one or more routing modules resident thereon. Additionally, each routing module may be configured as an active routing module, which is “on line” at boot-up, or a backup routing module, which is “off line” at boot-up and comes “on line” automatically upon failure of an active routing module. Naturally, fabrics 310a, 310b may also support different numbers of line modules and management modules, which may be configured as active or backup modules.

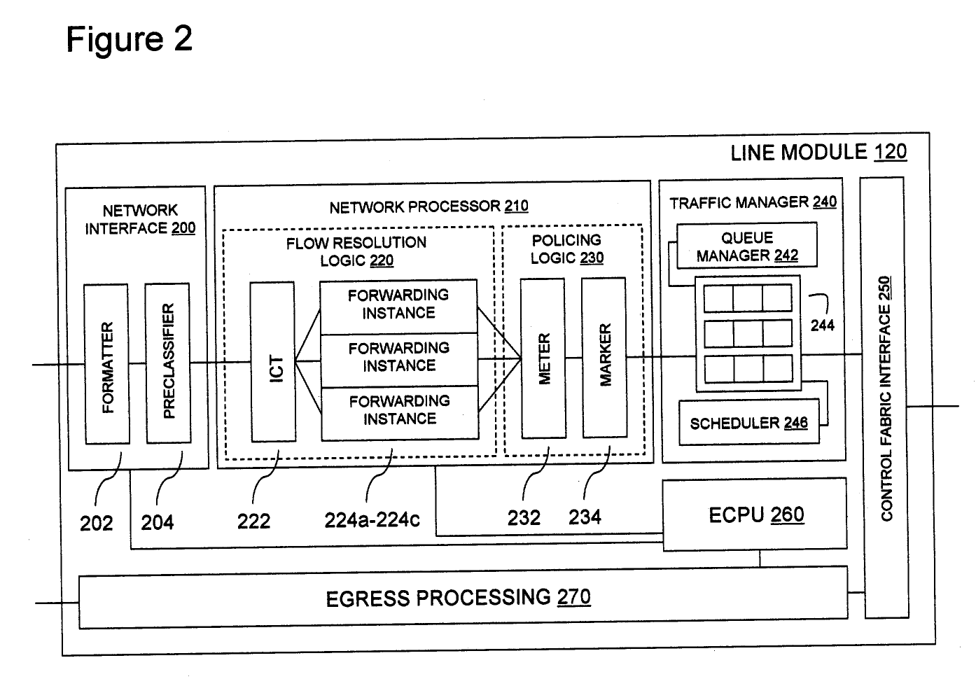

Turning to FIG. 2, a line module 120, which is representative of line modules 120a-120d, is shown in more detail. Line modules 120a-120d are affiliated with respective I/O modules (not shown) having ports for communicating with other network nodes (not shown) and performing electro-optical conversions. Packets entering line module 120 from its associated I/O module are processed at network interface 200. Packets may be fixed or variable length discrete information units of any protocol type. Packets undergoing processing described herein may be segmented and reassembled at various points in the routing node. In any event, at network interface 200, formatter 202 performs data link layer (Layer 2) framing and processing, assigns and appends an ingress physical port identifier and passes packets to preclassifier 204. Preclassifier 204 assigns a logical interface number (LIF) to packets based on port and/or channel (i.e. logical port) information associated with packets, such as one or more of an ingress physical port identifier, data link control identifier (DLCI), virtual path identifier (VPI), virtual circuit identifier (VCI), IP source address (IPSA) and IP destination address (IPDA), label switched path (LSP) identifier and virtual local area network (VLAN) identifier. Preclassifier 204 appends LIFs to packets. LIFs are shorthand used to facilitate assignment of packets to isolated groups of data forwarding resources and routing resources, as will be explained.

Packets are further processed at network processor 210. Network processor 210 includes flow resolution logic 220 and policing logic 230. At flow resolution logic 220, UFs from packets are applied to interface context table (ICT) 222 to associate packets with one of routing modules 320a, 320b, 320c. Packets are applied to one of forwarding instances 224a-224c depending on their routing module association. Forwarding instances 224a-224c are dedicated to routing modules 320a-320c, respectively. Packets associated with routing module 320a are therefore applied to forwarding instance 224a; packets associated with routing module 320b are applied to forwarding instance 224b; and packets associated with routing module 320c are applied to forwarding instance 224c. Once applied to the associated one of forwarding instances 224a-224c, information associated with packets is resolved to keys which are “looked up” to determine forwarding information for packets. Information resolved to keys may include information such as source MAC address, destination MAC address, protocol number, IPSA, IPDA, MPLS label, source TCP/UDP port, destination TCP/UDP port and priority (from e.g. DSCP, IP TOS, 802.1P/Q). Application of a key to a first table in the associated one of forwarding instances 224a-224c yields, if a match is found, an index which is applied to a second table in the associated one or forwarding instances 224a-224c to yield forwarding information for the packet in the form of a flow identifier (flow ID). Of course, on a particular line module, the aggregate of LIFs may be associated with fewer than all of routing modules 320a, 320b, 320c, in which case the number of forwarding instances on such line module will be fewer than the number of routing modules 320a, 320b, 320c.

Flow IDs yielded by forwarding instances 224a-224c provide internal handling instructions for packets. Flow IDs include a destination module identifier and a quality of service (QoS) identifier. The destination module identifier identifies the destination one of modules 120a-120d, 320a-320c, 330 for packets. Control packets, such as routing protocol packets (OSPF, BGP, IS-IS, RIP) and signaling packets (RSVP, LDP, IGMP) for which a match is found in one of forwarding instances 224a-224c are assigned a flow ID addressing the one of routing modules 320a-320c to which the one of forwarding instances 224a-224c is dedicated. This flow ID includes a destination module identifier of the one of routing modules 320a-320c and a QoS identifier of the highest priority. Data packets for which a match is found are assigned a flow ID addressing one of line modules 120a-120d. This flow ID includes a destination module identifier of one of line modules 120a-120d and a QoS identifier indicative of the data packet's priority. Packets for which no match is found are dropped or addressed to exception CPU (ECPU) 260 for additional processing and flow resolution. Flow IDs are appended to packets prior to exiting flow resolution logic 220.

At policing logic 230, meter 232 applies rate-limiting algorithms and policies to determine whether packets have exceeded their service level agreements (SLAs). Packets may be classified for policing based on information associated with packets, such as the QoS identifier from the flow ID. Packets which have exceeded their SLAs are marked as nonconforming by marker 234 prior to exiting policing logic 230.

Packets are further processed at traffic manager 240. Traffic manager 240 includes queues 244 managed by queue manager 242 and scheduled by scheduler 246. Packets are queued based on information from their flow ID, such as the destination module identifier and the QoS identifier. Queue manager 242 monitors queue depth and selectively drops packets if queue depth exceeds a predetermined threshold. In general, high priority packets and conforming packets are given retention precedence over low priority packets and nonconforming packets. Queue manager 242 may employ any of various known congestion control algorithms, such as weighted random early discard (WRED). Scheduler 246 schedules packets from queues, providing a scheduling preference to higher priority queues. Scheduler 246 may employ any of various known priority-sensitive scheduling algorithms, such as strict priority queuing or weighted fair queuing (WFQ).

Packets from queues associated with ones of line modules 120a-120d are transmitted on data fabric 110 directly to line modules 120a-120d. These packets bypass control fabric 310a and accordingly do not warrant further discussion herein. Data fabric 110 may be implemented using a conventional fabric architecture and fabric circuit elements, although constructing data fabric 110 and control fabric 310a using common circuit elements may advantageously reduce sparing costs. Additionally, while shown as a single fabric in FIG. 1, data fabric 110 may be composed of one or more distinct data fabrics.

Packets outbound to control fabric 310a from queues associated with ones of routing modules 320a-320c are processed at control fabric interface 250 using dedicated packet memory and DMA resources. Control fabric interface 250 segments packets outbound to control fabric 310a into fixed-length cells. Control fabric interface 250 applies cell headers to such cells, including a fabric destination tag corresponding to the destination module identifier, a token field and sequence identifier. Control fabric interface 250 transmits such cells to control fabric 310a, subject to the possession by control fabric interface 250 of a token for the fabric destination, as will be explained in greater detail below.

Packets outbound from control fabric 310a are processed at control fabric interface 250 using dedicated packet memory and DMA resources. Control fabric interface 250 receives cells from control fabric 310a and reassembles such cells into packets using the sequence identifiers from the cell headers. Control fabric interface 250 also monitors the health of fabric links to which it is connected by performing error checking on packets outbound from control fabric 310a. If errors exceed a predetermined threshold, control fabric interface 250 ceases distributing traffic on control fabric 310a and begins distributing traffic on backup control fabric 310b.

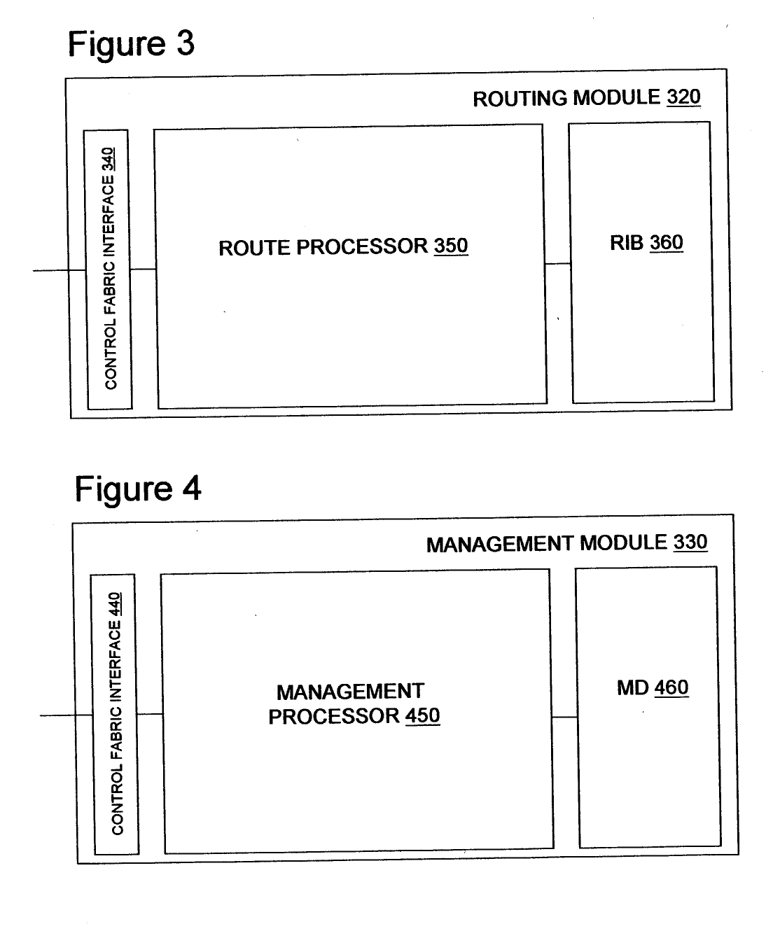

Turning to FIG. 3, a routing module 320, which is representative of routing modules 320a-320c, is shown in more detail. Control fabric interface 340 performs functions common to those described above for control fabric interface 250. Packets from control fabric 310a are further processed at route processor 350. Route processor 350 performs route calculations; maintains routing information base (RIB) 360; interworks with exception CPU 260 (see FIG. 2) to facilitate line card management, including facilitating updates to forwarding instances on line cards 120a-120d which are dedicated to routing module 320; and transmits control packets. With respect to updates of line card 120, for example, route processor 350 causes to be transmitted over control fabric 310a to exception CPU 260 updated associations between source MAC addresses, destination MAC addresses, protocol numbers, IPSAS, IPDAs, MPLS labels, source TCP/UDP ports, destination TCP/UDP ports and priorities (from e.g. DSCP, IP TOS, 802.1P/Q) and flow IDs, which exception CPU 260 instantiates on the one of forwarding instances 224a-224c dedicated to routing module 320. In this way, line cards 120a-120d are able to forward packets in accordance with the most current route calculations. RIB 360 contains information on routes of interest to routing module 320 and may be maintained in ECC DRAM. Exception CPU 260 is preferably a general purpose processor having associated ECC DRAM. With respect to control packet transmission on line card 120, for example, route processor 350 causes to be transmitted over control fabric 310a to egress processing 270 (see FIG. 2) control packets (e.g. RSVP) which must be passed-along to a next hop router node.

Turning to FIG. 4, management module 330 is shown in more detail. Management module 330 performs system-level functions including maintaining an inventory of all chassis resources, maintaining bindings between physical ports and/or channels on line modules 120a-120d and routing modules 320a-320c and providing an interface for chassis management. With respect to maintaining bindings between physical ports and/or channels on line modules 120 and routing modules 320a-320c, for example, management module 330 causes to be transmitted on control fabric 310a to exception CPU 260 updated associations between ingress physical port identifiers, DLCIs, VPIs, VCIs, IPSAs, IPDAS, LSP identifiers and VLAN identifiers on the one hand and LIFs on the other, which exception CPU 260 instantiates on preclassifier 204. In this way, line module 120 is able to isolate groups of data forwarding resources and routing resources. Management module 330 has a control fabric interface 440 which performs functions common with control fabric interfaces 250, 340, and a management processor 450 and management database 460 for accomplishing system-level functions.

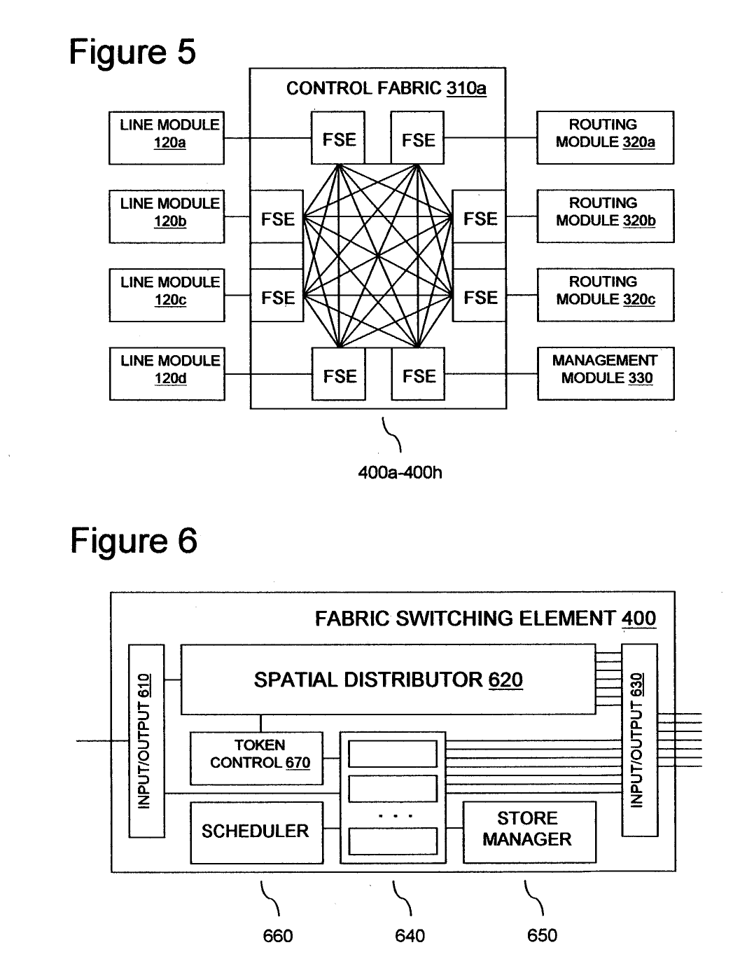

Turning to FIG. 5, control fabric 310a is shown in more detail. Control fabric 310a includes a complete mesh of connections between fabric switching elements (FSEs) 400a-400h which are in turn connected to modules 120a-120d, 320a-320c, 330, respectively. Control fabric 310a provides a dedicated full-duplex serial physical path between each pair of modules 120a-120d, 320a-320c, 330. FSEs 400a-400h spatially distribute fixed-length cells inbound to control fabric 310a and provide arbitration for fixed-length cells outbound from control fabric 310a in the event of temporary oversubscription, i.e. momentary contention. Momentary contention may occur since all modules 120a-120d, 320a-320c, 330 may transmit packets on control fabric 310a independently of one another. Two or more of modules 120a-120d, 320a-320c, 330 may therefore transmit packets simultaneously to the same one of modules 120a-120d, 320a-320c, 330 on their respective paths, which packets arrive simultaneously on the respective paths at the one of FSEs 400a-400h associated with the one of modules 120a-120d, 320a-320c, 330.

Turning finally to FIG. 6, an FSE 400, which is representative of FSEs 400a-400h, is shown in more detail. Cells Inbound to control fabric 310a arrive via input/output 610. The fabric destination tags from the cell headers are reviewed by spatial distributor 620 and the cells are transmitted via input/output 630 on the ones of physical paths reserved for the destination modules indicated by the respective fabric destination tags. Cells outbound from control fabric 310a arrive via input/output 630. These cells are queued by store manager 650 in crosspoint stores 640 which are reserved for the cells' respective source modules. Preferably, each crosspoint store has the capacity to store one cell. Scheduler 660 schedules the stored cells to the destination module represented by FSE 400 via input/output 610 based on any of various known fair scheduling algorithms, such as weighted fair queuing (WFQ) or simple round-robin.

Overflow of crosspoint stores 640 is avoided through token passing between the source control fabric interfaces and the destination fabric switching elements. Particularly, a token is provided for each source/destination module pair on control fabric 310a. The token is “owned” by either the control fabric interface on the source module (e.g. control fabric interface 250) or the fabric switching element associated with the destination module (e.g. fabric switching element 400) depending on whether the crosspoint store on the fabric switching element is available or occupied, respectively. When a control fabric interface on a source module transmits a cell to control fabric 310a, the control fabric interface implicitly passes the token for the cell's source/destination module pair to the fabric switching element. When the fabric switching element releases the cell from control fabric 310a to the destination module, the fabric switching element explicitly returns the token for the cell's source/destination module pair to the control fabric interface on the source module. Particularly, referring again to FIG. 6, token control 670 monitors availability of crosspoint stores 640 and causes tokens to be returned to source modules associated with crosspoint stores 640 as crosspoint stores 640 become available through reading of cells to destination modules. Token control 670 preferably accomplishes token return “in band” by inserting the token in the token field of a cell header of any cell arriving at spatial distributor 620 and destined for the module to which the token is to be returned. Alternatively, token control 670 may accomplish token return by generating an idle cell including the token in the token field and a destination tag associated with the module to which the token is to be returned, and providing the idle cell to spatial distributor 620 for forwarding to the module to which the token is to be returned.

It will be appreciated by those of ordinary skill in the art that the invention can be embodied in other specific forms without departing from the spirit or essential character hereof. The present description is therefore considered in all respects illustrative and not restrictive. The scope of the invention is indicated by the appended claims, and all changes that come within the meaning and range of equivalents thereof are intended to be embraced therein.

I claim:

1. A routing node, comprising:
a plurality of line modules;
a plurality of routing modules; and
a control fabric for transmission of traffic between the line modules and the routing modules.

2. The routing node of claim 1, wherein the control fabric includes a physical path dedicated for traffic involving a particular one of the line modules and a particular one of the routing modules.

3. The routing node of claim 1, wherein the control fabric includes ones of physical paths dedicated for traffic involving respective ones of the line modules and respective ones of the routing modules.

4. The routing node of claim 1, wherein transmission of traffic involving a particular one of the line modules and a particular one of the routing modules is dependent on possession of a token indicative of permission to transmit traffic involving the particular one of the line modules and the particular one of the routing modules.

5. The routing node of claim 1, wherein transmission of traffic involving ones of the line modules and respective ones of the routing modules is dependent on possession of respective ones of tokens indicative of respective ones of permissions to transmit traffic involving the particular one of the line modules and the particular one of the routing modules.

6. The routing node of claim 1, wherein ones of the routing modules include respective ones of route processors and respective ones of routing information bases.

7. The routing node of claim 1, further comprising a second control fabric for transmission of traffic between the line modules and the routing modules wherein the second control fabric activates based on an error rate.

8. The routing node of claim 1, wherein the control fabric is nonblocking.

9. The routing node of claim 1, wherein the control fabric is arranged such that oversubscription of one of the modules never results in a disruption of the transmission of traffic to any other one of the modules.

10. The routing node of claim 1, wherein the control fabric is arranged such that oversubscription of one of the modules never results in a starvation of any other one of the modules with respect to the transmission of traffic to the oversubscribed one of the modules.

11. A routing node including a plurality of modules and a control fabric wherein the control fabric includes ones of physical paths dedicated for transmission of traffic involving respective pairs of the modules and wherein at least one of the pairs includes at least one routing module.

12. The routing node of claim 11 wherein at least one of the pairs includes at least one line module.

13. The routing node of claim 11 wherein at least one of the pairs includes at least one management module.

14. The routing node of claim 11, wherein at least one of the pairs includes a first line module and a first routing module and at least one of the pairs includes the first line module and a second routing module.

15. The routing node of claim 11, wherein at least one of the pairs includes a first line module and a first routing module and at least one of the pairs includes a second line module and a second routing module.

16. A communication method for a routing node, comprising:
associating a port on a line module with a routing module;
receiving a packet on the port;
associating the packet with the routing module;
transmitting the packet from the line module to the routing module at least in part on a physical path dedicated for transmission of traffic between the line module and the routing module.

17. The method of claim 16, further comprising the steps of:
associating a second port on the line module with a second routing module;
receiving a second packet on the second port;
associating the second packet with the second routing module; and
transmitting the second packet from the line module to the second routing module at least in part on a physical path dedicated for transmission of traffic between the line module and the second routing module.

18. The method of claim 16, wherein the port is a physical port.

19. The method of claim 16, wherein the port is a logical port.

20. A communication method for a routing node, comprising:
associating on a line module a packet flow and a routing module;
receiving on the line module a packet in the flow;
associating the packet with the routing module;
transmitting the packet from the line module to the routing module at least in part on a physical path dedicated for transmission of traffic between the line module and the routing module.

21. The method of claim 20, further comprising the steps of:
associating on the line module a second packet flow and a second routing module;
receiving on the line module a second packet in the second packet flow;
associating the second packet with the second routing module; and
transmitting the second packet from the line module to the second routing module at least in part on a physical path dedicated for transmission of traffic between the line module and the second routing module.
